(19) United States
(12) Patent Application Publication
(10) Pub. No.: US 2006/0131883 A1
(43) Pub. Date: Jun. 22, 2006

(54) Externally pressurized connection

(76) Inventor: Erik M. Howard, Baytown, TX (US)

Correspondence Address: LAW OFFICES OF MARK L. BERRIER, 3811 BEE CAVES ROAD, SUITE 204, AUSTIN, TX, 78746, US

(21) Appl. No.: 11/185,913

(22) Filed: Jul. 20, 2005

Related U.S. Application Data
(60) Provisional application No. 60/589,543, filed on Jul. 20, 2004.

(51) Int. Cl. F16L 23/00

(52) U.S. Cl. 285/412

(57) ABSTRACT

Systems and methods for coupling conduits such as pipe sections, where the resulting conduit (e.g., pipeline) will be externally pressurized. One embodiment comprises first and second flanges and a seal ring. The flanges have male and female mating surfaces, respectively. The mating surfaces form a tapered space in which the seal ring is positioned. The space between the mating surfaces is tapered so that it is wider at an end which is exposed to pressure external to the connection and narrower at an end which is exposed to pressure internal to the connection. The mating surfaces of the flanges and inner and outer surfaces of the seal ring may be conic sections, where the male mating surface and inner seal ring surface form a smaller angle with the axis of the connection and the female mating surface and outer seal ring surface form a larger angle with the axis.

### RELATED APPLICATIONS

This application claims priority to U.S. Provisional Patent Application No. 60/589,543, entitled “Systems and Methods for Making High-Pressure Pipe Connections,” by Erik M. Howard, filed Jul. 20, 2004, which is fully incorporated by reference as if set forth herein in its entirety.

### BACKGROUND

1. Field of the Invention

The invention relates generally to connections between conduits such as pipes, and more particularly to systems and methods for coupling conduits wherein the pressure external to the connections between the conduits is greater than the pressure internal to the connections.

2. Related art

The use of pipelines or other conduits to carry pressurized fluids is widely known. For instance, such pipelines may be used to transport natural gas or other fluid hydrocarbons. Still other pipelines may be used to transport corrosive, toxic or otherwise dangerous fluids.

The pipelines used in these applications typically consist of a number of pipe sections which are connected end-to-end to form a single pipeline. Typically, the pipe sections are joined by means of couplings or connectors which consist of a set of flanges attached to the ends of the pipe sections. The flanges are bolted or held together in some other manner to form a continuous conduit or to connect to fixed equipment.

It is important to ensure that the couplings between pipe sections form tight seals. This is particularly true in systems which are designed to handle dangerous fluids (e.g., those which are operated at high pressures or high temperatures, or those which carry dangerous fluids.) Pipe couplings therefore normally include a gasket or some other type of seal located between the flanges of the couplings to provide a good seal. An example of a standard API coupling is illustrated in FIGS. 1A and 1B. FIG. 1A shows the disassembled flanges and seal ring, while FIG. 1B shows the assembled coupling. The seal rings used in the couplings must likewise be designed to withstand the high pressures and are often constructed of metal rather than a more elastic, but weaker and less durable material.

Typically, these pipelines are internally pressurized. That is, the pressure at the interior of the pipeline is greater than the pressure at the exterior of the pipeline. The connections in these internally pressurized pipelines are designed to prevent fluids in the pipelines from leaking out through the connections. Connections that use standard API flanges and seal rings are not directional in nature and are designed to prevent leakage through the connections, whether the connections are pressurized internally or externally. Some other types of connections, such as the tapered-seal connection shown in FIG. 2, are designed specifically to prevent leakage when the connection is internally pressurized. It can be seen in FIG. 2 that the seal ring between the flanges has a tapered configuration so that, when the connection is internally pressurized, the wedge-shaped seal ring is driven more tightly into the corresponding wedge-shaped gap between the flanges, thereby increasing the effectiveness of the seal.

While conduits (and connections) in most applications are at least slightly internally pressurized, there are increasing numbers of applications in which the conduits are externally pressurized. That is, the pressure external to the conduit is greater than the pressure internal to the conduit. These applications may for example, include subsea oil production applications in which tremendous pressure is exerted on the connection by water at the ocean floor.

Connections in these applications could use standard API flanges (as shown in FIGS. 1A and 1B.) The tapered-seal connection illustrated in FIG. 2, however, would not be suitable for these applications because, rather than driving the wedge-shaped seal ring more tightly into the wedge-shaped gap between the mating surfaces of the flanges, the greater external pressure would tend to push the tapered seal ring out of the corresponding gap between the flanges. As a result, the contact pressure between the mating surfaces of the flanges (and the integrity of the seal) may be reduced.

It would therefore be desirable to provide systems and methods for improving the effectiveness of the seal in an externally pressurized connection between pipe sections or other conduits.

### SUMMARY OF THE INVENTION

One or more of the problems outlined above may be solved by the various embodiments of the invention. Broadly speaking, the invention comprises systems and methods for coupling conduits such as pipe sections, where the resulting conduit (e.g., pipeline) will be externally pressurized. In one embodiment, the connection comprises a pair of flanges between which is formed an annular gap that tapers from a greater width near the exterior of the flanges to a narrower width near the interior of the flanges. The connection also comprises a seal ring having a tapered cross-section generally corresponding to the tapered gap between the flanges.

One alternative embodiment comprises a connection including first and second coupling members and a seal ring. The male coupling member has a male mating surface and the female coupling member has a female mating surface. The seal ring is positioned between the male and female mating surfaces to provide a seal between them. The male and female mating surfaces are configured to form a tapered space in which the seal ring is positioned. The space between the male and female mating surfaces is tapered so that it is wider at an end which is exposed to pressure external to the connection and narrower at an end which is exposed to pressure internal to the connection. In one embodiment, the seal ring is a tapered seal ring having inner and outer surfaces complementary to the male and female mating surfaces, respectively. The male and female mating surfaces and inner and outer surfaces of the seal ring may, for example, be conic sections, where the male mating surface and inner seal ring surface form a smaller angle with the axis of the connection and the female mating surface and outer seal ring surface form a larger angle with the axis. The coupling members may comprise pipe flanges, enclosures, caps or other types of coupling members.

Another alternative embodiment comprises a method including providing mating coupling members that form a tapered space for a seal ring, positioning the seal ring between the coupling members, securing the coupling members to apply a first amount of contact pressure between the coupling members and the seal ring, and then externally pressurizing the connection, thereby applying an additional amount of contact pressure between the coupling members and the seal ring.

Another alternative embodiment comprises a seal ring for use in an externally pressurized connection, wherein the seal ring has an inner surface for contacting a male connection member and an outer surface for contacting a female connection member. The thickness of the seal ring between the inner and outer surfaces is thicker at a first end which is configured to be positioned closer to the male connection member and narrower at a second end which is configured to be positioned closer to the female connection member.

Numerous other embodiments are also possible.

### BRIEF DESCRIPTION OF THE DRAWINGS

Other objects and advantages of the invention may become apparent upon reading the following detailed description and upon reference to the accompanying drawings.

FIGS. 1A and 1B are diagrams illustrating a conventional API flanged pipe connection in accordance with the prior art.

FIG. 2 is a diagram illustrating an internally pressured connection that utilizes tapered seal ring to couple a pair of pipe flanges in accordance with the prior art.

FIG. 3 is a cross-sectional view of a disassembled pipe connection in accordance with one embodiment.

FIG. 4 is a cross-sectional view of an assembled pipe connection in accordance with one embodiment.

FIGS. 5A-5C are a set of diagrams illustrating several alternative types of seal rings that can be used in an externally-pressurizable connection as shown in FIGS. 3 and 4.

FIG. 6 is a cross-sectional view of a connection that is used to cap off a pipe in accordance with one embodiment.

While the invention is subject to various modifications and alternative forms, specific embodiments thereof are shown by way of example in the drawings and the accompanying detailed description. It should be understood, however, that the drawings and detailed description are not intended to limit the invention to the particular embodiment which is described. This disclosure is instead intended to cover all modifications, equivalents and alternatives falling within the scope of the present invention as defined by the appended claims.

### DETAILED DESCRIPTION OF PREFERRED EMBODIMENTS

One or more embodiments of the invention are described below. It should be noted that these and any other embodiments described below are exemplary and are intended to be illustrative of the invention rather than limiting.

As described herein, various embodiments of the invention comprise systems and methods for coupling conduits such as pipe sections that will be externally pressurized. These systems and methods make use of a pair of flanges that have mating surfaces which form a tapered gap when the flanges are coupled together. The gap tapers from a greater width near the exterior of the flanges to a narrower width near the interior of the flanges. A corresponding seal ring is positioned between the mating surfaces of the coupled flanges. The seal ring has a tapered cross-section corresponding to the tapered gap between the mating surfaces of the flanges.

In one embodiment, a male flange has a mating surface that forms a conic section. This male mating surface extends forward from the face of the flange. The other flange has a female mating surface that also forms a conic section. The female mating surface is recessed into the female flange. The conic section of the male mating surface forms an angle with the axis of the flange that is smaller than the angle formed by the conic section of the female mating surface with the axis of the female flange. Thus, the gap between the male and female mating surfaces is wider at the end of the gap nearest the male flange and narrower at the end of the gap nearest the female flange.

When the connection is made (assembled,) the seal ring is placed between the flanges and the flanges are coupled together. In one embodiment, the flanges are coupled together by means of bolts that are placed through holes in the flanges and secured by nuts that are threaded onto the bolts. The nuts are tightened on the bolts to draw the flanges closer together and thereby apply contact pressure between the mating surfaces and the seal ring. When the connection is externally pressurized, the seal ring is pushed by the external pressure from the wider end of the gap to the narrower end of the gap, thereby increasing the contact pressure between the mating surfaces and the seal ring and increasing the effectiveness of the seal between the flanges.

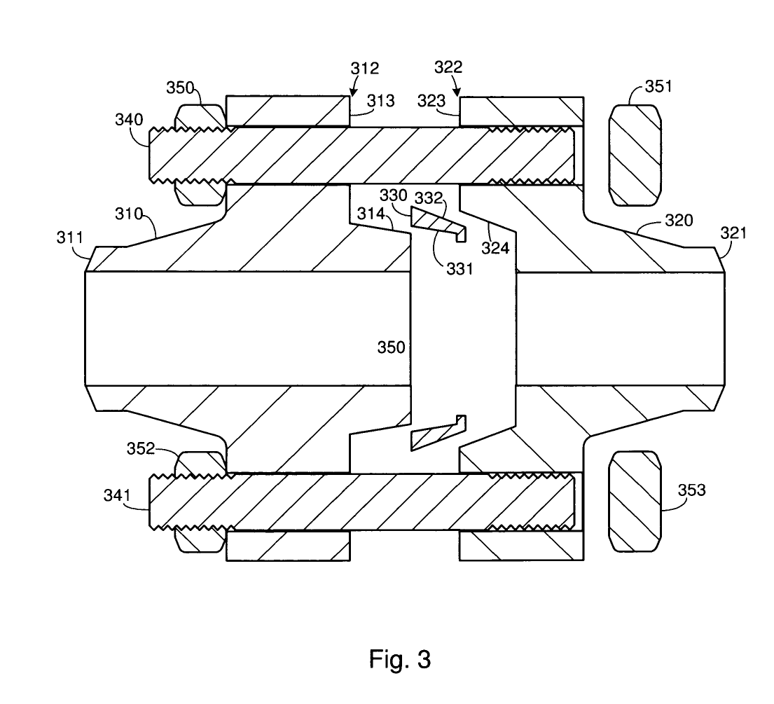

Referring to FIG. 3, a diagram illustrating the structure of a pipe connection in accordance with one embodiment is shown. In this figure, the connection is disassembled. For purposes of clarity, only the connection itself (including the flanges, a seal ring and connecting bolts/nuts) is shown. The pipes that are being coupled together by means of the flanges are omitted from the figure.

FIG. 3 depicts a connection that is suitable for externally pressurized pipelines. The connection primarily includes a male flange 310, a female flange 320, and a seal ring 330. Each of flanges 310 and 320 has beveled edges (311 and 321, respectively) at the back of the respective flange bodies to allow the flanges to be welded to corresponding pipe sections.

At the front of each flange is a forward surface (312, 322) that is configured to be coupled to the other flange. The forward surface of each flange includes an outer portion (313, 323) which includes bolt holes to allow the flanges to be coupled together, and an inner mating surface (314, 324) that is configured to contact the seal ring (330) and thereby seal the connection between the flanges.

As noted above, male flange 310 has a male mating surface 314 that extends forward (away from the back portion of the flange that will be welded to the pipe section) from the outer portion 313 of the forward flange surface 312. This may also be referred to as the nose of the flange. This male mating surface forms a conic section. The cross-section of the male mating surface appears as a flat surface which is angled with respect to the axis (centerline) of the flange. The rotation of this flat surface around the axis of the flange forms the conic section of the male mating surface. The male mating surface may also be referred to as the nose of the flange.

Female flange 320 likewise has a mating surface 324 which forms a conic section. Female mating surface 324 is complementary to male mating surface 314 in that it forms a recessed area in the forward surface 322 of female flange 320 to accommodate the nose of the male flange when the two flanges are coupled together. The angle of female mating surface 324 with respect to the axis of the flanges is greater than the angle formed between male mating surface 314 and the axis of the flanges.

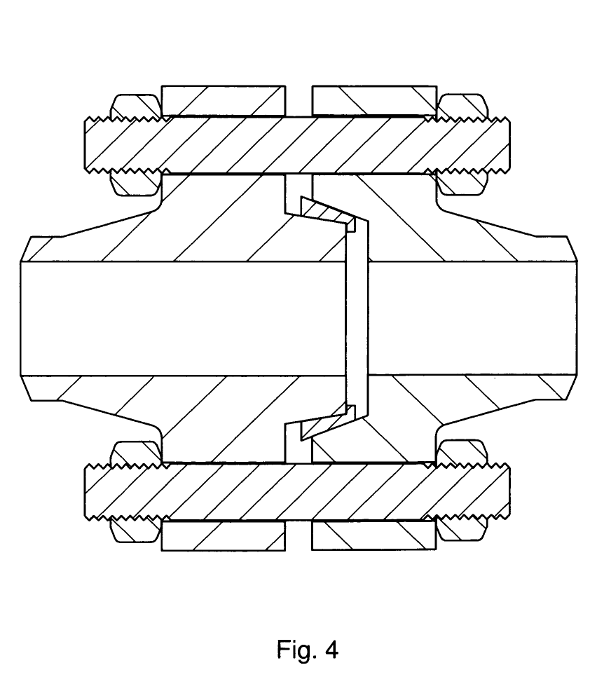

When male flange 310 is coupled to female flange 320, the nose of the male flange fits within the recess of the female flange (see FIG. 4.) Seal ring 330 is positioned in the gap between the male and female mating surfaces (314, 324). Since the angles of male mating surface 314 and female mating surface 324 with respect to the axis of the flanges are different, the gap between the mating surfaces is tapered. This is apparent in the cross-sectional view of FIG. 3. Because the angle between female mating surface 324 and the flanges' axis is greater than the angle between male mating surface 314 and the axis of the flanges, the gap is wider at the end which is closer to the male flange (and which is open to the exterior of the assembled connection) and narrower at the end which is closer to the female flange (and which is open to the interior of the assembled connection.)

Seal ring 330 is tapered to match male mating surface 314 and female mating surface 324. In other words, seal ring has an inner surface 331 that forms a conic section matching male mating surface 314 and an outer surface 332 that forms a conic section matching female mating surface 324. Consequently, when seal ring 330 is positioned in the gap between male and female mating surfaces 314 and 324, there is contact between almost all of the seal ring surfaces and the corresponding mating surfaces of the flanges (rather than having contact over only a relatively small surface area of the seal ring.) Moreover, the wedge-shaped (in cross-section) seal ring is complementary to the wedge-shaped gap.

When the connection of FIG. 3 is assembled as shown in FIG. 4, the nuts (e.g., 350-353) are tightened on the bolts (e.g., 340-341) to apply contact pressure between the mating surfaces of the flanges and the seal ring. Because the mating surfaces of the flanges are angled with respect to the flange axis, instead of being perpendicular to the axis, the tightening of the nuts/bolts an generate a great deal of contact pressure, in comparison to the amount of pressure that can be directly applied by the nuts to the flanges.

After the connection is tightened, it is placed into operation, during which the connection is externally pressurized. That is, the pressure external to the connection is greater than the pressure internal to the connection. As a result, the higher external pressure is applied to the wider end of seal ring 330 (the left end in FIGS. 3 and 4,) while the lower internal pressure is applied to the more narrow end of the seal ring (the right end in FIGS. 3 and 4.) The higher pressure on the larger surface area causes tapered seal ring 330 to be driven more tightly into the wedge-shaped gap between mating surfaces 314 and 324 of the flanges, increasing the effectiveness of the seal between the flanges.

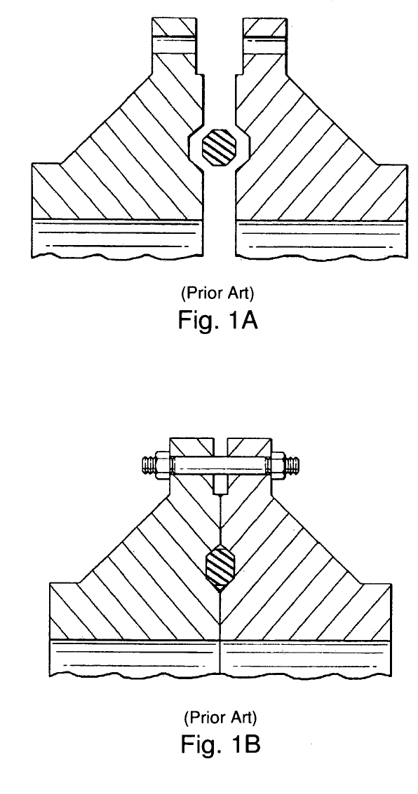

This configuration is more effective than the prior art connections for several reasons. In the API flange connection mentioned above (see FIG. 1,) the seal ring is designed to be crushed by the flanges when they are assembled. The seal ring is thereby deformed so that it conforms to the seal seat (the indentation) in the face of each of the flanges. While it is desirable to conform the seal ring to the face of each flange, the fact that this is accomplished by crushing the seal ring may be problematic. In order to deform the seal ring (which is typically a relatively soft metal,) it is necessary to apply sufficient contact pressure to the metal of the seal ring to cause it to move in a semi-fluid fashion to conform to the shape of the flange face. When additional pressure is applied in the form of external pressurization of the connection, the seal ring has already been sufficiently stressed to cause it to deform. The external pressure may therefore continue to deform the seal ring, reducing the effectiveness of the seal between the flanges.

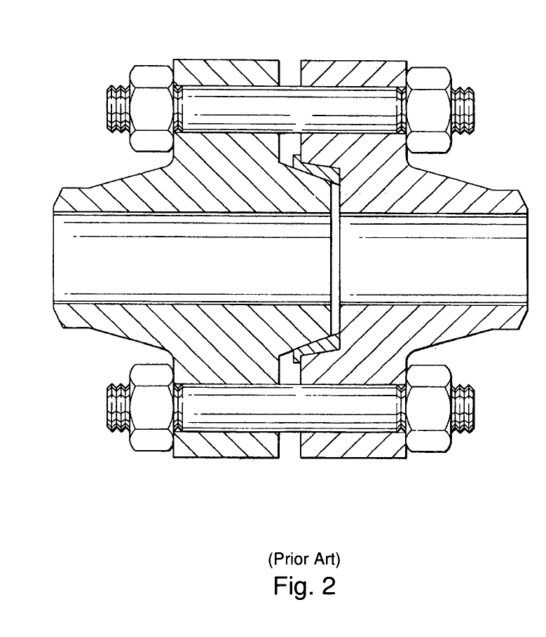

The present connection is also more effective than the tapered-seal connection illustrated in FIG. 2. It can be seen that the seal ring in the connection of FIG. 2 is thicker at the end nearest the male flange than at the end nearest the female flange. Likewise, the gap between the mating surfaces of the flanges is narrower on the side of the male flange and wider on the side of the female flange. In this connection, pressure internal to the pipes pushes the seal ring more tightly into the gap between the flanges, while external pressure pushes the seal ring out of the gap. This connection is therefore well suited for use in internally pressurized pipelines, but is not well suited to externally pressurized pipelines, as the greater external pressure ends to push the seal ring out of the gap between the flanges, thereby reducing the contact pressure of the seal ring and reducing the effectiveness of the seal.

In contrast to the prior art connection of FIG. 2, the present connection is effective for use in externally pressurized systems because the seal ring and the gap between the mating surfaces of the flanges are configured in a manner that is the opposite of these components of FIG. 2. In other words, the seal ring and the gap between the flanges of the present embodiment are both wider on the side of the male flange and narrower on the side of the female flange. As a result, the greater external pressure forces the seal ring to be pushed into the gap, rather than being pushed out of the gap, as would be the case in the connection of FIG. 2. The effect of the external pressure is to wedge the seal ring more tightly into the gap between the mating surfaces of the flanges, increasing the contact pressure between the seal ring and the mating surfaces and increasing the effectiveness of the seal.

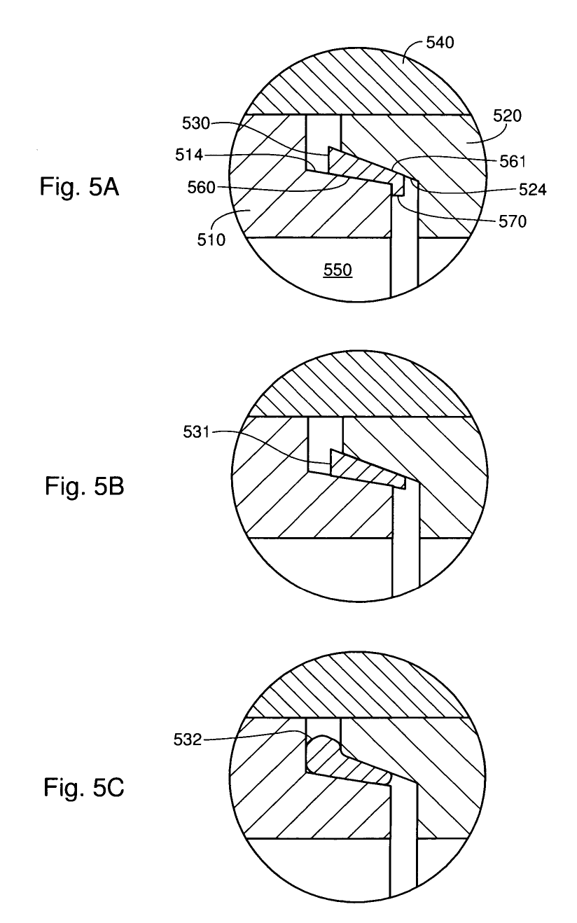

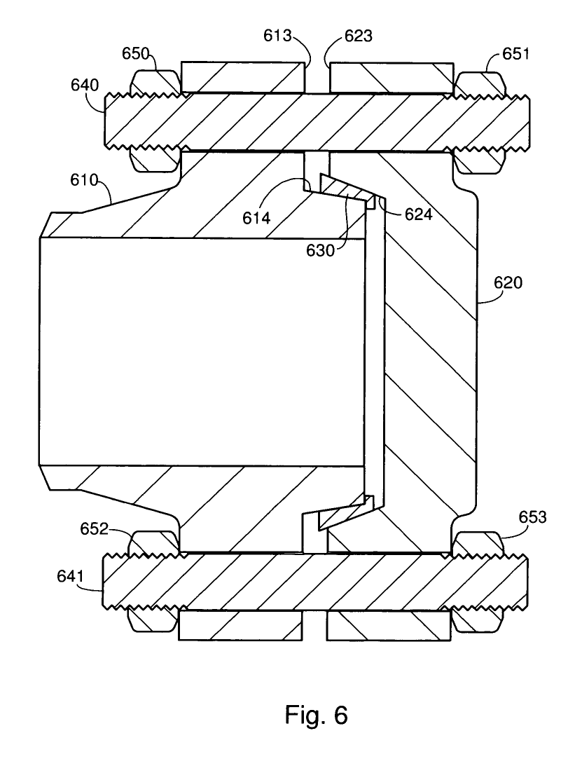

It should be noted that the embodiment illustrated in FIG. 3 is exemplary, and that many alternative embodiments are possible. In these alternative embodiments, various features of the connection may differ from the specific features of the embodiment of FIG. 3. For example, a different type of seal may be used in the connection, the connection may be used to seal an enclosure rather than a pipe coupling, the connection may utilize coupling means other than bolts, the mating surfaces may not be conic in shape, and so on. Several examples of these different features are illustrated in FIGS. 5-6, which are described below.

Referring to FIGS. 5A-5C, three figures illustrating alternative types of seal rings are shown. Each of these figures is a close-up cross-sectional view of a pipe connection centered on the seal ring and surrounding structure. FIG. 5A depicts a first type of tapered seal ring that has a lip which limits movement of the seal ring toward the male flange. FIG. 5B depicts a second type of tapered seal ring that does not have a lip of the type illustrated in FIG. 5A. FIG. 5C depicts a third seal ring that is not tapered, but is instead crushed during assembly of the connection to conform to the gap between the male and female flanges.

Referring to FIG. 5A, seal ring 530 has a tapered cross-section which is complementary to the gap between the mating surfaces of the connection flanges. The inner surface 560 of seal ring 530 is a conic section that is complementary to male mating surface 514 of flange 510, while the outer surface 561 of the seal ring is a conic section that is complementary to female mating surface 524 of flange 520. Additionally, seal ring 530 has a lip 570 that extends radially inward from the narrow end of the seal ring. When the connection is assembled, lip 570 limits the movement of seal ring 530 toward male flange 510. (A portion of bolt 540 is shown at the top of the figure, while the interior of the connection 550 is shown at the bottom of the figure.)

Referring to FIG. 5B, a seal ring 531 which is similar to seal ring 530 is used in the connection. Seal ring 531 has a tapered cross-section which has an inner surface that is a conic section complementary to male mating surface 514 and an outer surface that is a conic section complementary to female mating surface 524. Seal ring 531 differs from seal ring 530 in that it does not have a lip extending radially inward from the narrow end of the seal ring. When the connection is assembled, seal ring 531 is therefore not prevented from moving toward male flange 510 in the same manner as seal ring 530 (although the conic shape of male mating surface 514 will serve to restrict this movement.)

Referring to FIG. 5C, a different type of seal ring is used. In the embodiments of FIGS. 5A and 5B, the seal ring is typically made of a relatively hard metal which does not significantly deform as a result of contact pressure between the seal ring and the mating surfaces of the flanges (and may therefore be re-used. In the embodiment of FIG. 5C, on the other hand, the seal is made of a softer metal. Seal ring 532 initially has a cross-sectional shape that is not complementary to mating surfaces 514 and 524. For instance, seal ring 532 may have a circular cross-section. When the connection is assembled, seal ring 532 is crushed between the mating surfaces of the flanges and is thereby conformed to the shapes of the mating surfaces as shown in FIG. 5C. Because of this deformation of seal ring 532, the seal ring typically cannot be re-used.

In addition to the variations in the type of seal that is used in a connection, alternative embodiments may involve the use of connection components that are not pipe flanges. That is, the connection is not used as a means to couple adjoining pipe sections. One example of such a connection is shown in FIG. 6.

Referring to FIG. 6, a connection that is used to cap off a pipe that is not currently being used is shown. A similar connection could be used to seal off the opening of a compartment or enclosure that is subjected to elevated external pressures. Such enclosures may, for instance, contain electronics, sensors or other equipment that could be damaged by the external pressure.

In the embodiment of FIG. 6, the connection includes a male flange 610 that is connected to the pipe section to be capped off, a female cap 620 to terminate the opening of the pipe section, and a seal ring 630. Each of flange 610 and cap 620 has an outer portion (613, 623) that has a set of bolt holes through which bolts (e.g., 640-641) can be placed and secured with corresponding nuts (e.g., 650-653.)

Flange 610 has a face formed by the outer portion 613 and a male inner mating surface 614 that is configured to contact seal ring 630. Cap 620 likewise has a face formed by outer portion 623 and an inner female mating surface 614 that is configured to contact seal ring 630. The contact of each of mating surfaces 614 and 624 with seal ring 630 forms a seal between flange 610 and cap 620.

In this embodiment, male and female mating surfaces 614 and 624 and seal ring 630 are configured in the same manner as the corresponding portions of the connection illustrated in FIGS. 3 and 4. Likewise, seal ring 630 functions (in conjunction with the mating surfaces of flange 610 and cap 620) in the same manner as seal ring 330, so that the pressurization of the connection (with the external pressure greater than the internal pressure) causes the contact pressure between the mating surfaces and the seal ring to be increased, thereby increasing the effectiveness of the seal.

The benefits and advantages which may be provided by the present invention have been described above with regard to specific embodiments. These benefits and advantages, and any elements or limitations that may cause them to occur or to become more pronounced are not to be construed as critical, required, or essential features of any or all of the claims. As used herein, the terms “comprises,” “comprising,” or any other variations thereof, are intended to be interpreted as non-exclusively including the elements or limitations which follow those terms. Accordingly, a system, method, or other embodiment that comprises a set of elements is not limited to only those elements, and may include other elements not expressly listed or inherent to the claimed embodiment.

While the present invention has been described with reference to particular embodiments, it should be understood that the embodiments are illustrative and that the scope of the invention is not limited to these embodiments. Many variations, modifications, additions and improvements to the embodiments described above are possible. It is contemplated that these variations, modifications, additions and improvements fall within the scope of the invention as detailed within the following claims.

What is claimed is:

1. A connection comprising:
a first coupling member having a male mating surface;
a second coupling member having a female mating surface; and
a seal ring positioned between the male mating surface and the female mating surface to provide a seal between the male mating surface and the female mating surface;
wherein the male mating surface and the female mating surface are configured to form a tapered space in which the seal ring is positioned and wherein the tapered space between the male mating surface and the female mating surface is wider at an end which is exposed to pressure external to the connection and narrower at an end which is exposed to pressure internal to the connection.

2. The connection of claim 1, wherein the seal ring is a tapered seal ring having an inner surface complementary to the male mating surface and an outer surface complementary to the female mating surface.

3. The connection of claim 2, wherein the inner and outer surfaces of the seal ring, the male mating surface and the female mating surface comprise conic sections.

4. The connection of claim 3, wherein the male mating surface and the inner surface of the seal ring form a first angle with an axis of the first member, wherein the female mating surface and the outer surface of the seal ring form a second angle with an axis of the second member, wherein the first angle is less than the second angle.

5. The connection of claim 1, wherein the first and second members comprise pipe flanges.

6. The connection of claim 1, wherein one of the first and second members comprises a cap.

7. The connection of claim 6, wherein one of the first and second members comprises a flange.

8. The connection of claim 6, wherein one of the first and second members comprises an enclosure.

9. A method comprising:
providing a first coupling member having a male mating surface and a second coupling member having a female mating surface, wherein in an assembled configuration, the male and female mating surfaces form a tapered space for a seal ring, wherein the space between the male mating surface and the female mating surface is wider at an end which is closer to the exterior of the coupling members and narrower at an end which is closer to the exterior of the coupling members;
positioning a seal ring between the male and female mating surfaces;
applying contact pressure between each of the male and female mating surfaces and the seal ring;
securing the male coupling member to the female coupling member; and
pressuring the exterior of the coupling members with respect to the interior of the coupling members and thereby increasing the contact pressure between each of the male and female mating surfaces and the seal ring.

10. The method of claim 9, wherein the seal ring is a tapered seal ring having an inner surface complementary to the male mating surface and an outer surface complementary to the female mating surface.

11. The method of claim 10, wherein the inner and outer surfaces of the seal ring, the male mating surface and the female mating surface comprise conic sections.

12. The method of claim 11, wherein the male mating surface and the inner surface of the seal ring form a first angle with an axis of the first member, wherein the female mating surface and the outer surface of the seal ring form a second angle with an axis of the second member, wherein the first angle is less than the second angle.

13. The method of claim 9, wherein the first and second members comprise pipe flanges.

14. The method of claim 9, wherein one of the first and second members comprises a cap.

15. The method of claim 14, wherein one of the first and second members comprises a flange.

16. The method of claim 14, wherein one of the first and second members comprises an enclosure.

17. A seal ring for use in an externally pressurized connection, comprising:
a metal seal ring having an inner surface for contacting a male connection member and an outer surface for contacting a female connection member;
wherein a thickness of the seal ring between the inner and outer surfaces is thicker at a first end which is configured to be positioned closer to the male connection member than the female connection member and narrower at a second end which is configured to be positioned closer to the female connection member than the female connection member.

18. The seal ring of claim 17, wherein the inner surface forms a first conic section that forms a first angle with an axis of symmetry of the seal ring, wherein the outer surface forms a second conic section that forms a second angle with the axis of symmetry of the seal ring, and wherein the first angle is less than the second angle.

19. The seal ring of claim 17, wherein the seal ring further comprises a lip extending radially inward from the second end of the seal ring.
